(19) United States
(12) Patent Application Publication
(10) Pub. No.: US 2025/0290351 A1
(43) Pub. Date: Sep. 18, 2025

(54) Zip Tie Handcuffs with Handle

(71) Applicant: Anthony Jeremiah Bayne, Lomita, CA (US)

(72) Inventor: Anthony Jeremiah Bayne, Lomita, CA (US)

(21) Appl. No.: 19/080,121

(22) Filed: Mar. 14, 2025

Related U.S. Application Data
(60) Provisional application No. 63/565,192, filed on Mar. 14, 2024.
(60) Provisional application No. 63/566,347, filed on Mar. 17, 2024.

(51) Int. Cl. E05B 75/00

(52) U.S. Cl. CPC E05B 75/00

(57) ABSTRACT

To reduce the danger of an arresting police officer injuring his fingers when using zip tie handcuffs to control an arrestee, and to provide a means to tether an arrestee wearing zip tie handcuffs to a fixture, disclosed is a pair of three-stemmed zip tie handcuffs with securing means. One of the three stems (e.g., the middle stem) can be used as a handle and/or a means to tether an arrestee to a fixture to allow the police officer to conduct other business. The middle stem may be of a different size/shape than the other two stems so that the officer can identify it by touch alone. In this way the officer does not have to look at the stem(s) to know what stem is in his hand and can focus on scanning his immediate environment for danger.

### FEDERALLY SPONSORSED RESEARCH OR DEVELOPMENT

Not applicable.

### FIELD OF THE INVENTION

The invention relates generally to zip ties, and more particularly to zip tie handcuffs including a means to better control a person who has been restrained with them.

### BACKGROUND

Zip ties, also known as “cable ties” and “tie wraps”, are well known fastening devices. They frequently comprise a head and an elongated stem (also known as a “strap”) that are made from an integrally formed single piece of plastic. The head includes a slot containing a pawl mechanism, and the stem includes a toothed surface on one side that interacts with the slot's pawl when the stem's tapered end/tail is inserted into the slot. The stem is designed so that there is a ratcheting effect when the tapered end is inserted into the slot and the teeth engage the pawl mechanism. The ratcheting effect prevents the stem from being pulled out of the slot.

Some law enforcement agencies use zip ties, or a version of them called “flex cuffs”, or “zip tie handcuffs” (e.g., two joined zip ties) to secure the hands of an arrestee by attaching them around the arrestee's wrists when the arrestee's hands are behind his back. As used herein, an “arrestee” is defined broadly to include a suspect, defendant, person of interest, subject, or detainee.

Most zip ties and zip tie handcuffs are single use and must be cut off to be removed (e.g., so that an arrestee can be booked, admitted to a hospital, etc.). Some include a lock, or other mechanism (e.g. a pawl release) to allow them to be undone and reused.

When a zip tie is tightened around an arrestee's wrists, a gap in the zip tie often exists between the zip tie and arrestee's wrists that an officer inserts his/her fingers through, to hold onto the zip tie while escorting the arrestee to a patrol car. When an arrestee makes a violent sudden twisting motion, or trips, it can injure the officer's fingers. Alternatively, an officer may try to control the arrestee by holding onto a zip tie's stem. Since a stem is essentially a thin strip of plastic, it is difficult for an officer to maintain a firm grasp on it.

Some flex cuffs provide for two zip ties that are joined by a single head. Examples include “CTAM “Krowd Kontrol Flex Cuffs Zip Tie Handcuffs” (https://www.cabletiesandmore.com/zip-tie-hand-cuffs) that are essentially two zip ties joined by a short rigid bridge. While the bridge is thicker than a zip tie's stem, since it is short, it does not solve the problem of avoiding injury to an officer's fingers when an arrestee twists away violently, or trips. Another is “EZ-Cuff 500-D Double Loop Cuffs” (https://www.galls.com/ez-cuff-500-d-double-loop-cuff?PMSRCH=zip%20ties).

Other flex cuffs have the end/tail of each strap held together by another structure. For example, Harrington, et al “HANDCUFF APPARATUS” (US Pub. No. 2009/0077773 A1) teaches a “rivet assembly” to hold the free ends of two straps together. Others teach flex cuffs that may include a “draw ring” to tighten a strap(s), such as Parsons “FLEXIBLE ONE TIME USE RESTRAINTS” (U.S. Pat. No. 11,268,304 B2).

In addition to endangering an officer's fingers and being difficult to hold onto, another shortcoming of zip tie handcuffs is that they do not address the context in which they are used; namely, a scenario where arrestees outnumber available metal handcuffs. This may occur at the scene of a riot, a gang fight, or “a mostly peaceful protest”, where a police officer has multiple arrestees and only one car to place them into. This creates a problem for the police in maintaining control over numerous arrestees. Backseats of a law enforcement vehicle (e.g., a 4-door sedan) can generally hold two arrestees. Officers do not want an arrestee in the front passenger seat of a patrol car, because an arrestee can damage radio/electronic equipment, access a weapon, etc. When a police officer stands over an arrestee in zip tie handcuffs to make sure the arrestee doesn't run away it prevents the officer from interviewing witnesses, securing a crime scene, etc.

Therefore, there remains a need for a zip tie handcuff that reduces the risk of injury to an officer's fingers when used by an officer to escort an arrestee, as well as a means to free an officer to handle other duties when the arrestee is bound with a zip tie handcuff.

### BRIEF SUMMARY OF CERTAIN INVENTIVE ASPECTS

To reduce the risk of a law enforcement officer injuring his fingers when escorting an arrestee restrained in zip tie handcuffs, and to create a means to tether an arrestee to a fixture, disclosed is a new pair of three stemmed zip tie handcuffs, and method, that provides a handle to control a handcuffed arrestee, and/or tether to secure an arrestee to a fixed location or object, so that the officer can conduct other police business (e.g., secure a crime scene).

In a preferred embodiment, the invention comprises a pair of zip tie handcuffs, wherein the zip tie handcuffs further comprise a head, three pawls; and three elongated stems that extend from the head, wherein the head, pawls and stems are of an integral one-piece construction.

In an alternate embodiment, the invention comprises a three stemmed zip tie of a unified one-piece construction, wherein each stem extends substantially in the same direction from a single head of the zip tie; and each stem comprises a width, thickness and length. Further, one of the stems is of a different shape and/or size than the other two stems.

In yet another alternate embodiment, the invention includes a method to detain an individual, comprising the following steps in order: encompassing each wrist of an individual having two wrists with a separate single stem of a pair of zip tie handcuffs, tightening the two stems; and attaching a third stem of the pair of zip tie handcuffs to a fixture to tether the individual to the fixture. The method may further comprise a user selecting a stem by the user's sense of touch (e.g., feeling the shape and/or size of the stem with the user's hand/fingers).

In yet another alternate embodiment, the invention comprises a first zip tie that further comprises two stems integral to a head, wherein the head includes two pawls and a channel to receive a separate, second zip tie's stem. The second zip tie thus attached to the first zip tie is useable to secure the first zip tie to a fixture. In this embodiment the second zip tie may be of a different material, shape, and/or size than the first zip tie.

Without limiting the scope of this invention as expressed by the claims that follow, its more prominent features will now be discussed briefly. After considering this discussion, and particularly after reading the section entitled “DETAILED DESCRIPTION”, one will understand how the features of this invention provide advantages that include the improved zip-tie handcuffs with securing means.

Although the following description of exemplary embodiments will be presented in the context of a law enforcement officer detaining an arrestee, other environments are contemplated to be included (e.g., a teacher detaining a rowdy juvenile in school, an orderly anchoring a suicidal patient, etc.).

The invention, now having been briefly summarized, may be better visualized by turning to the following drawings wherein like elements are referenced by like numerals.

To the accomplishment of the above and related objects, the present invention may be embodied in the form illustrated in the accompanying drawings. However, the drawings are illustrative only, and changes may be made in the specific construction(s) illustrated and described that are within the scope of the claims.

### BRIEF DESCRIPTION OF THE DRAWINGS

FIG. 1 shows a top perspective view of a preferred embodiment of a pair of three stemmed zip tie handcuffs with a securing means with the right strap inserted through the head.

FIG. 2 is a top view of three stemmed zip tie handcuffs.

FIG. 3. is a bottom view of FIG. 2

FIG. 4 is a front view of FIG. 2.

FIG. 5 is a back view of FIG. 2.

FIG. 6 is a right-side view of FIG. 2.

FIG. 7 is a left-side view of FIG. 2.

FIG. 8 is a bottom perspective view of an alternate embodiment of zip tie handcuffs with a securing means including the three stems splayed.

FIG. 9 is a top elevated perspective view of an alternate embodiment including three stems extending from the head in different directions.

FIG. 10 is view of FIG. 9 with the first and third stems inserted through the head.

FIG. 11 is a view of FIG. 9 with all stems inserted through the head.

FIG. 12 shows an arrestee secured to a fixture using a pair of three stemmed zip tie handcuffs.

FIG. 13 shows a law enforcement officer using an alternate embodiment of a pair of zip tie handcuffs to control an arrestee using the middle/second stem as a handle.

### DETAILED DESCRIPTION

The present invention solves the aforesaid problems by providing a new pair of three stemmed zip tie handcuffs. The three stems can be of the same size and shape. Alternatively, the second/middle stem may be thicker, wider, a different shape, and/or longer than the other two stems, and can be used as a handle to control an arrestee or used to tether an arrestee to a fixture (e.g., a fence). When the second stem is wider than the other stems used to bind an arrestee's wrists, the additional width provides more surface area for a user's palm/fingers to contact the stem for better control. A longer second stem ensures that a large enough loop can be made to allow a user to get at least three fingers, or part of the user's palm into the loop created by the stem when it is fed through the head, so that an arrestee's sudden movement will less likely injure the user's fingers. These and other features, aspects and embodiments of the invention will be described in more detail below.

The presence of broadening words and phrases such as “one or more,” “at least,” “but not limited to”, or other like phrases, shall not be read to mean that the narrower case is intended, or required, where such broadening phrases may be absent.

The objects and features of the present invention will become more fully apparent from the following description and appended claims, taken in conjunction with the accompanying drawings. Understanding that these drawings depict only typical embodiments of the invention and are not to be considered limiting of its scope, the invention will be described and explained with additional specificity and detail using the accompanying drawings.

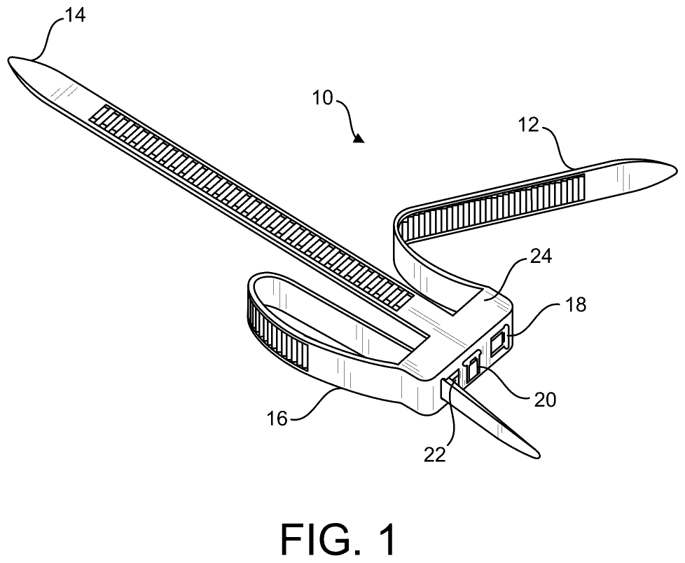

FIG. 1 shows a top perspective view of a preferred embodiment of a pair of zip tie handcuffs 10 with three stems 12, 14, and 16. The second, middle stem 14 is preferably used as a securing means to anchor/tether an arrestee to a fixture, or a control means (i.e., handle for law enforcement). The third, right stem 16 is shown flexed and inserted through a channel containing one of the head's 24 three pawls 18, 20, and 22, namely the third, right, pawl 22. The zip tie handcuffs' 10 stems 12, 14, and 16 are preferably of an integral one-piece unitary construction with the head 24 and pawls 18, 20, and 22. Each of the three stems 12, 14 and 16 are flexible to be bent and fed into a channel containing a pawl 18, 20, or 22 through the head 24. The stems 12, 14, and 16 are shown of equal width, thickness, and length, but the second, middle stem 14 (for example) that is used for securing an arrestee to a fixture, or used as a handle, may be longer, wider, thicker, etc., than the other two stems 12 & 16. The zip tie handcuffs 10 may be made of UV stabilized nylon, or other suitable material, or a combination of them (e.g., recycled plastic).

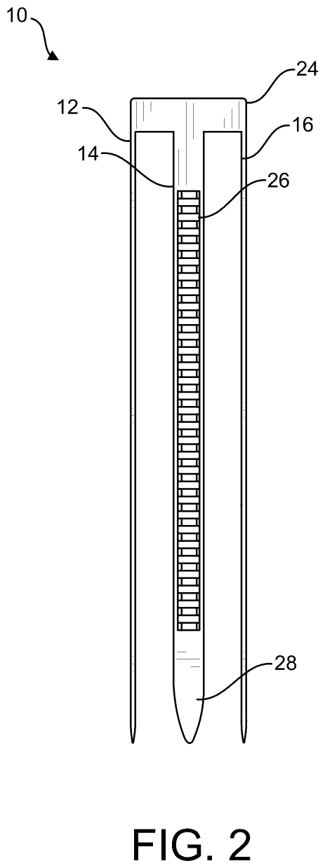

FIG. 2 shows a top view of a pair of three stemmed zip tie handcuffs 10 with three stems 12, 14, and 16 extending from the head 24 that point substantially in the same direction for ease of carry/storage and are of a one-piece unitary construction with the head 24 of the handcuffs 10. Each stem 12, 14, and 16 comprise one or more teeth 26 on an exterior facing surface 28 of the stem 14. The teeth 26 provide a non-slip surface for a user (e.g., a police officer) to grip onto when the cuffs 10 have been used to secure an arrestee (not shown). The second stem 14 is substantially perpendicular to at least one of the other two stems' 12 & 16, and the first and third stems 12 & 16 may be substantially parallel to each other for ease of storage/carry.

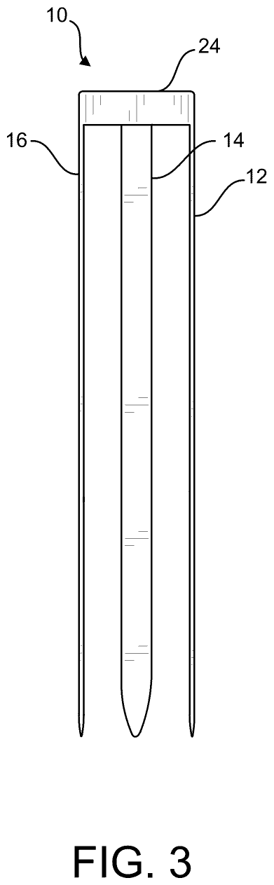

FIG. 3 shows a bottom view of a pair of zip tie handcuffs 10 with three stems 12, 14, and 16 extending from the head 24 pointing substantially in the same direction for ease of carry/storage and are of a one-piece unitary construction with the head 24. The bottom of the stems 12, 14 and 16 preferably do not have teeth 26, but in an alternate embodiment may have teeth instead of, or in addition to, the teeth 26 on an exterior facing surface 28 (not shown). The stems 12, 14 and 16 taper at their ends.

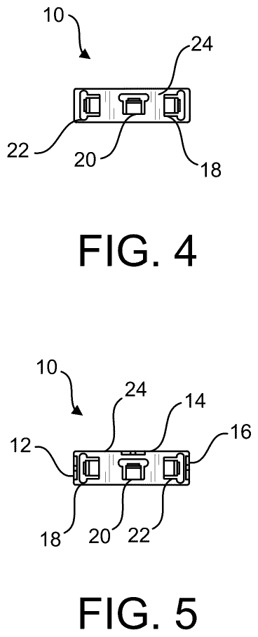

FIG. 4 shows a front view of a pair of zip tie handcuffs 10. The head 24 includes three pawls 18, 20, and 22 that are preferably of a one-piece unified construction with the head 24. However, in an alternative embodiment a paw1 18, 20, or 22, or each of them, or parts of them, may be made of a separate material (e.g., stainless steel). Further, in a preferred embodiment the handcuff's 10 are of a single use (i.e., must be cut off an arrestee), but in an alternative embodiment one or more of the stems 18, 20 & 22 may be unlockable to make the handcuffs 10 reuseable.

FIG. 5 shows a back view of a pair of zip tie handcuffs 10, comprising a head 24, three stems 12, 14 & 16, and three pawls 18, 20 & 22 that are preferably of a unified one-piece construction.

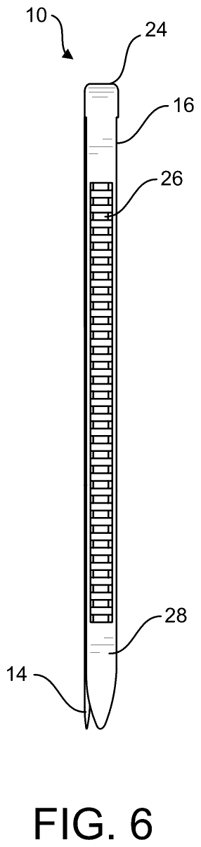

FIG. 6 shows a right-side view of a pair of zip tie handcuffs 10. The right stem 16 extends from the head 24 and includes at least one tooth 26 on it's exterior surface 28. The right stem 16 is substantially parallel to the first/left side stem 12. The second/middle stem 14 is preferably useable to secure an arrestee to a fixture, or useable as a handle to control an arrestee who is wearing the handcuffs 10.

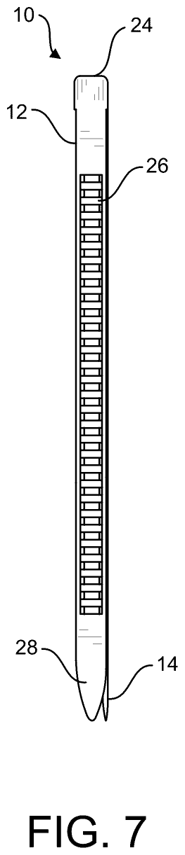

FIG. 7 shows a left side view of a pair of zip tie handcuffs 10. The first/left side stem 12 extends from the head 24 and includes at least one tooth 26 on its exterior surface 28. The left stem 12 is substantially perpendicular to the middle stem 14.

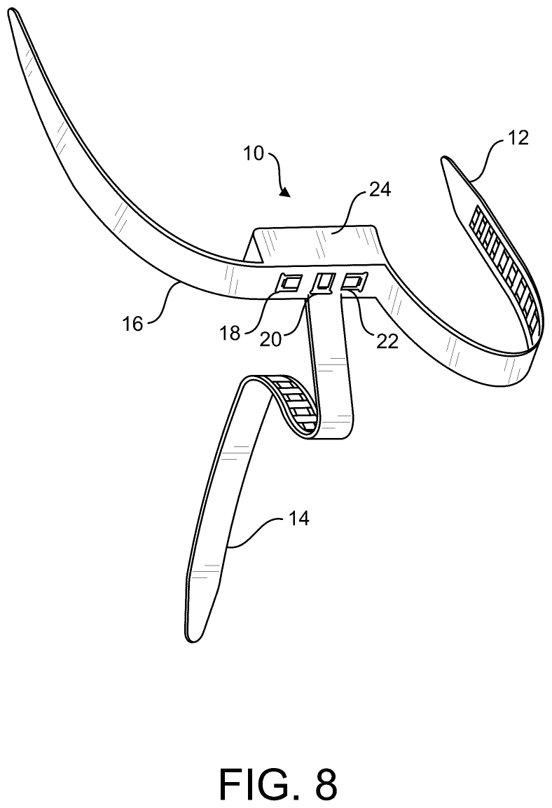

FIG. 8 shows a bottom perspective view of an alternate embodiment of zip tie handcuffs 10 including three stems 12, 14 & 16 splayed, and three pawls 18, 20 & 22 integral to the material of the head 24. The third/right stem 16 extends from the head 24 in different direction that the other two stems 12 & 14.

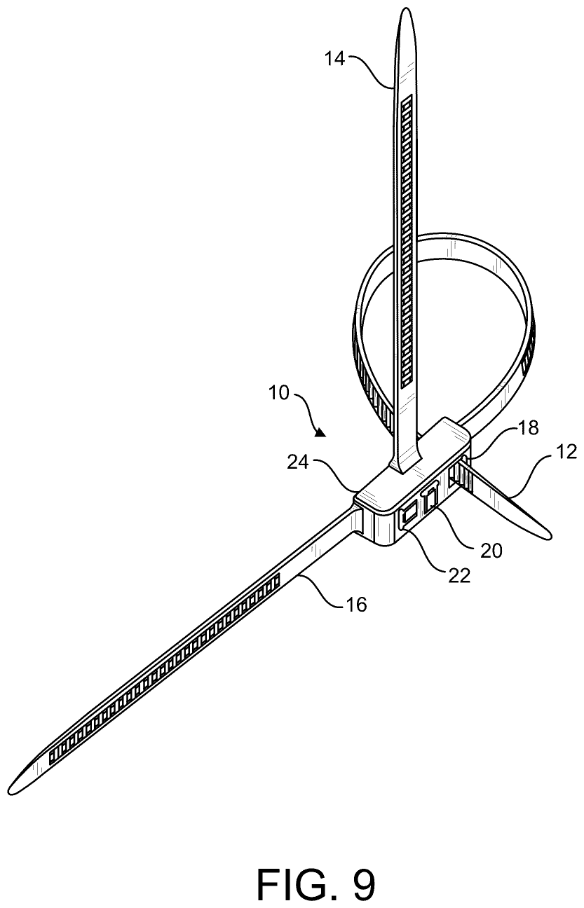

FIG. 9 shows a top elevated perspective view of another alternate embodiment of a pair of zip tie handcuffs 10 that comprise a head 24, three stems 12, 14 & 16, and three pawls 18, 20 & 22. The stems 12, 14 & 16 extend from the head 24 in three different directions, with the left stem 12 shown inserted through the head 24. The pair of zip tie handcuffs 10 are preferably of a unified, one-piece construction, but may be made of attachable components made of different materials (e.g., steel). For example, a stem 14 may be made of metal and attachable to the head 24.

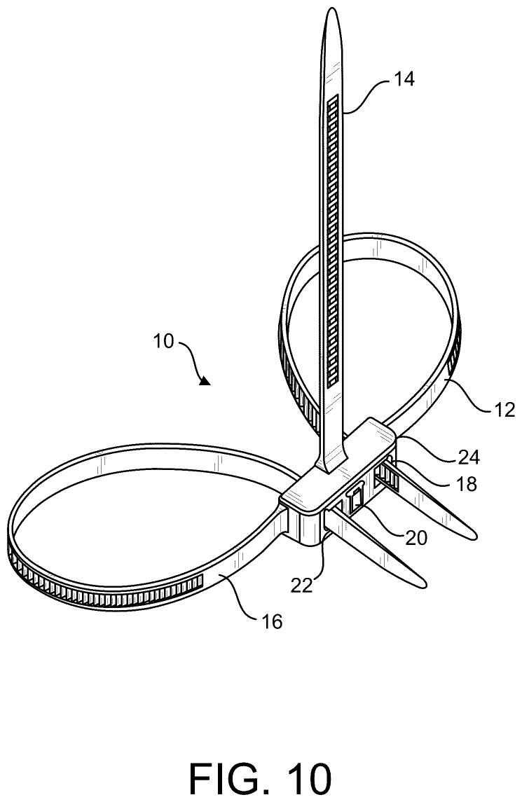

FIG. 10 shows the zip tie handcuffs 10 of FIG. 9 with the (first) left 12 and (third) right 16 stem inserted through the head 24. In this alternative configuration, the three stems 12, 14 & 16, head 24 and pawls 18, 20 & 22 are preferably of a unified one-piece construction. The (second) middle stem 14 extends from the head 24 substantially perpendicular to the other two stems 12 & 16 to make it readily identifiable as the stem 14 used for control/tethering an arrestee to a fixture.

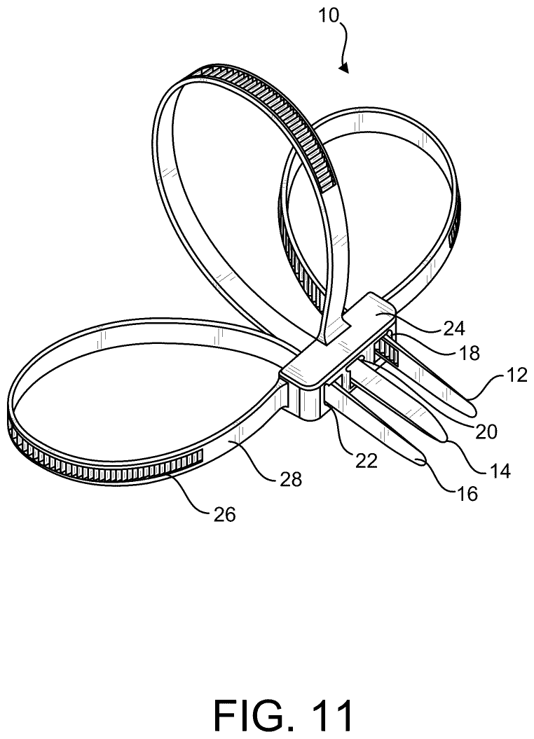

FIG. 11 shows the zip tie handcuffs 10 of FIG. 9 with all three stems 12, 14 & 16 threaded through the head 24 so that pawls 18, 20 & 22 engage the teeth 26 on the exterior surface's 28 of each stem 12, 14 & 16. The second stem 14 is substantially perpendicular to the other two stems 12 & 16 to make it easy to identify for use as a handle and/or anchoring device.

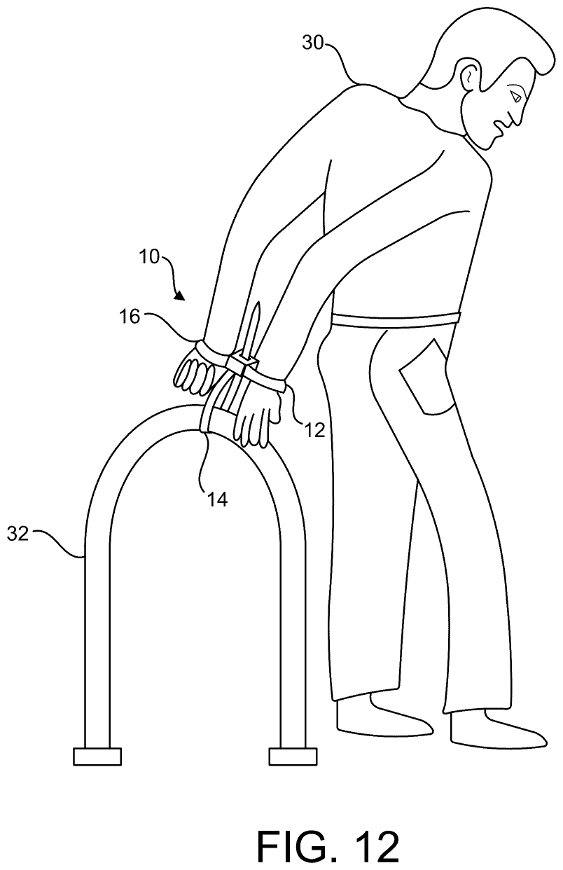

FIG. 12 shows the shows three stemmed zip tie handcuffs 10 tethering an arrestee 30 to a fixture (a bicycle rack fixture) 32 by the second/middle stem 14 that may be longer, wider and/or thicker than the other two stems 12 & 16 to make it easier for a police officer user (not shown) to identify what each stem's 12, 14 & 16 purpose is when in a fast moving emergency situation. For example, when the second stem 14 is wider or thicker than the other two stems 12 & 16, a police officer does not have to look at the stem 14 to tell what its purpose is, because the officer can distinguish, by touch alone, the difference between it 14 and the other stems 12 & 16 while keeping his/her eyes on the arrestee/surrounding environment for danger.

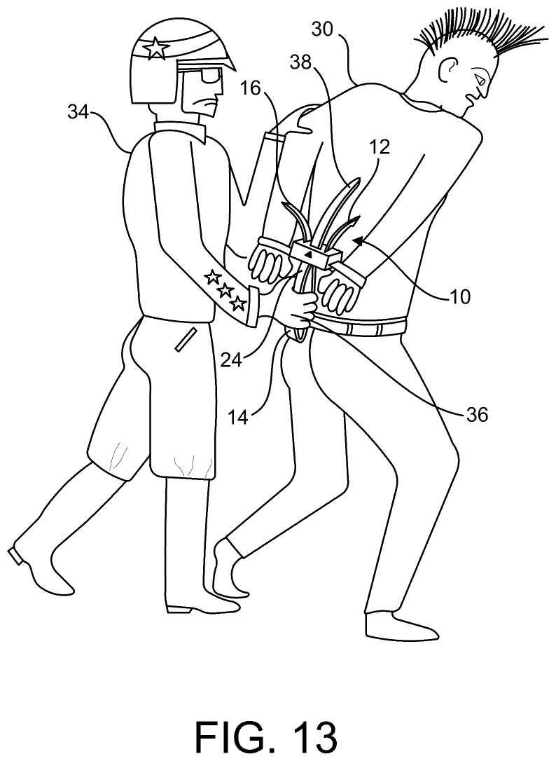

FIG. 13 shows a law enforcement officer 34 escorting an arrestee 30 while using the second stem 14 of the zip tie handcuffs 10 as a handle to control the arrestee 30. In this view, the second stem 14 is larger (longer, thicker, and wider) than the two other stems 12 & 16, so that the stem 14 can create a loop to be used as a slip resistant handle. Preferably the stem's 14 loop is large enough to allow an officer 34 to get at least three fingers through it, so that an arrestee 30 cannot easily twist away and injure the officer's 34 fingers 36. Additionally, the handcuffs 10 may include a matching indentation, mark 38, and/or a raised surface, on a distal end of a stem 14 and the head 24 for an officer 34 to quickly know where a stem 14 (or any of them) is supposed to enter the head 24.

The disclosed invention teaches a new tool for use in securing an arrestee to minimize risk of injury to a law enforcement officer, and alternate embodiments, that unlike prior art tools, provide a safer way to control, or anchor an arrestee using zip tie cuffs. Many alterations and modifications may be made by those having ordinary skill in the art without departing from the spirit and scope of the invention. The Applicant intends to encompass any structure presently existing or developed in the future that performs the same function.

Therefore, it must be understood that the illustrated embodiments have been set forth only for the purposes of examples and that they should not be taken as limiting the invention as defined by the following claims. For example, notwithstanding the fact that the elements of a claim are set forth below in certain combinations, it must be expressly understood that the invention includes other combinations of fewer, more, or different ones of the disclosed elements.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted, and what incorporates the essential idea of the invention.

I claim:

1. An apparatus, comprising:
a pair of zip tie handcuffs, wherein the zip tie handcuffs further comprise a head, three pawls; and
three elongated stems that extend from the head, wherein the three elongated stems are of an integral one-piece construction with the head.

2. The three elongated stems of claim 1, comprising at least one tooth on a surface of each stem.

3. The surface of each stem of claim 2, comprising an exterior facing surface.

4. The exterior facing surfaces of claim 3, wherein at least two of the exterior facing surfaces face in the opposite direction of each other.

5. The second elongated stem of claim 1, further comprising a width that is substantially perpendicular to a width of one of the other two stems.

6. The second elongated stem of claim 1, further being positioned so that the first and third stem are on the left-hand side and right-hand side of the second stem, respectively.

7. The three elongated stems of claim 1, wherein the stems are flexible.

8. The three elongated stems of claim 1, wherein at least two of the stems are substantially of an equal length.

9. The three elongated stems of claim 1, wherein at least two of the stems are of substantially the same width and thickness.

10. The three elongated stems of claim 1, wherein at least one of the stems comprises a mark on a distal end of the stem that matches a mark on the head.

11. The three elongated stems of claim 1, wherein one of the stems is useable to tether the zip tie handcuffs to a fixed object.

12. The zip tie handcuffs of claim 1, wherein the second stem is identifiable by touch.

13. The zip tie handcuffs of claim 1, further being constructed of UV Stabilized Nylon.

14. An apparatus comprising:
a three stemmed zip tie of a unified one-piece construction, wherein each stem extends substantially in the same direction from a single head of the zip tie; and
each stem further comprises a width, thickness and length.

15. The second stem of claim 14, wherein the second stem's length is greater than the length of one of the two other stems.

16. The second stem of claim 14, wherein the second stem's thickness is greater than the thickness of one of the two other stems.

17. The second stem of claim 14, wherein the second stem's width is greater than the width of one of the two other stems.

18. The second stem of claim 14, further comprising a different shape than one of the other two stems so that it is identifiable by touch.

19. A method to detain an individual comprising the following steps in order:
encompassing each wrist of an individual having two wrists with a separate single stem of a pair of zip tie handcuffs,
tightening the two stems; and
attaching a third stem of the pair of zip tie handcuffs to a fixture to tether the individual to the fixture.

20. The method of claim 19, further including the step of choosing a stem by using the sense of touch.
